(19) United States
(12) Patent Application Publication
(10) Pub. No.: US 2025/0070302 A1
(43) Pub. Date: Feb. 27, 2025

(54) VEHICLE HAVING BATTERY VENT GAS THERMAL MANAGEMENT SYSTEM

(71) Applicant: FCA US LLC, Auburn Hills, MI (US)

(72) Inventors: Venkata Krishna Mohan Chagarlamudi, Rochester Hills, MI (US); Skreekanth Surapaneni, Oakland, MI (US); Uday Kiran Mahakali, Novi, MI (US)

(21) Appl. No.: 18/455,795

(22) Filed: Aug. 25, 2023

(51) Int. Cl. H01M 10/625; H01M 10/48; H01M 10/613; H01M 10/63; H01M 10/6565; H01M 50/30

(52) U.S. Cl. CPC H01M 10/625; H01M 10/486; H01M 10/613; H01M 10/63; H01M 10/6565; H01M 50/30; H01M 2220/20

(57) ABSTRACT

A vehicle having an exhaust pipe and a battery pack including a plurality of battery cells stored in a housing having at least one vent that is configured to discharge battery exhaust gases generated by the plurality of battery cells to the exhaust pipe. A heat exchanger is configured to cool the plurality of battery cells using a coolant that flows between the heat exchanger and the battery pack through a battery pack cooling loop. A coolant jacket surrounds a section of the exhaust pipe that is in communication with the heat exchanger and configured to cool the battery exhaust gases in the exhaust pipe using the coolant that flows between the heat exchanger and the coolant jacket through a battery exhaust gas cooling loop. A three-way valve controls flow of the coolant between the battery pack cooling loop and the battery exhaust gas cooling loop.

### FIELD

The present disclosure relates to a vehicle having a battery vent gas thermal management system.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. These flammable gases may be ignited by the high temperature of the battery, which may result in a fire. Accordingly, in the event of a thermal runaway, it is desirable that the vehicle include features that assist in preventing, or at least substantially minimizing, the ignition of various gases that are generated during the thermal runaway.

### SUMMARY

This section provides a general summary of the disclosure, and is not a comprehensive disclosure of its full scope or all of its features.

According to an aspect of the present disclosure, there is provided a vehicle that includes an internal combustion engine in communication with an exhaust pipe; a battery pack including a plurality of battery cells stored in a housing having at least one vent that is configured to discharge battery exhaust gases generated by the plurality of battery cells to the exhaust pipe; a heat exchanger that is configured to cool the plurality of battery cells using a coolant that flows between the heat exchanger and the battery pack through a battery pack cooling loop; a coolant jacket surrounding a section of the exhaust pipe that is in communication with the heat exchanger and configured to cool the battery exhaust gases in the exhaust pipe using the coolant that flows between the heat exchanger and the coolant jacket through a battery exhaust gas cooling loop; and a three-way valve that controls flow of the coolant between the battery pack cooling loop and the battery exhaust gas cooling loop, wherein the three-way valve prevents flow through the battery pack cooling loop during discharge of the battery exhaust gases from the exhaust pipe.

The vehicle may also include a controller and a sensor in communication with the controller that is configured to generate either a signal indicative of a temperature within the battery pack or a signal indicative of a pressure within the battery pack, wherein the controller is configured to control the three-way valve to control the flow of the coolant between the battery pack cooling loop and the battery exhaust gas cooling loop based on the signals generated by the sensor.

If the signal indicative of temperature or the signal indicative of pressure is above a predetermined threshold, the controller is configured to instruct the three-way valve to direct the flow of coolant to the battery exhaust gas cooling loop.

The battery pack cooling loop may include an inlet line that extends between the heat exchanger and the battery pack and an outlet line that extends between the battery pack and the heat exchanger.

The inlet line includes a first pump for drawing the coolant from the heat exchanger toward the battery pack and a second pump for drawing the coolant from the battery pack back to the heat exchanger.

The three-way valve may be located in the inlet line.

The coolant jacket is configured to receive the coolant from the three-way valve and return the coolant to the heat exchanger through a return line that extends between the coolant jacket and the heat exchanger.

The return line includes a third pump for drawing the coolant from the coolant jacket back to the heat exchanger.

The first, second, and third pumps are each in communication with the controller, and when the coolant is flowing through the battery exhaust gas coolant loop, the controller controls each of the first pump and the third pump.

The third pump does not operate while the coolant is flowing in the battery pack coolant loop.

The at least one vent is connected to the exhaust pipe by a conduit having a non-return valve positioned therein.

A non-return valve may be located in the exhaust pipe downstream from the internal combustion engine and upstream from a location where the conduit is connected to the exhaust pipe.

The battery pack coolant loop may include at least one heat sink positioned in the housing that is configured to exchange heat with the coolant.

The controller is configured to at least one of increase and decrease an amount of cooling provided to the battery pack based on signals indicative of temperature received from the sensor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 schematically illustrates a vehicle according to a principle of the present disclosure including a battery pack coolant loop and a battery exhaust gas coolant loop, with a flow of coolant flowing through the battery pack coolant loop;

FIGS. 2 and 3 are perspective views of an example battery pack that may be used in the vehicle illustrated in FIG. 1; and

FIG. 4 schematically illustrates the vehicle illustrated in FIG. 1, with the flow of coolant flowing through the battery exhaust gas coolant loop.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

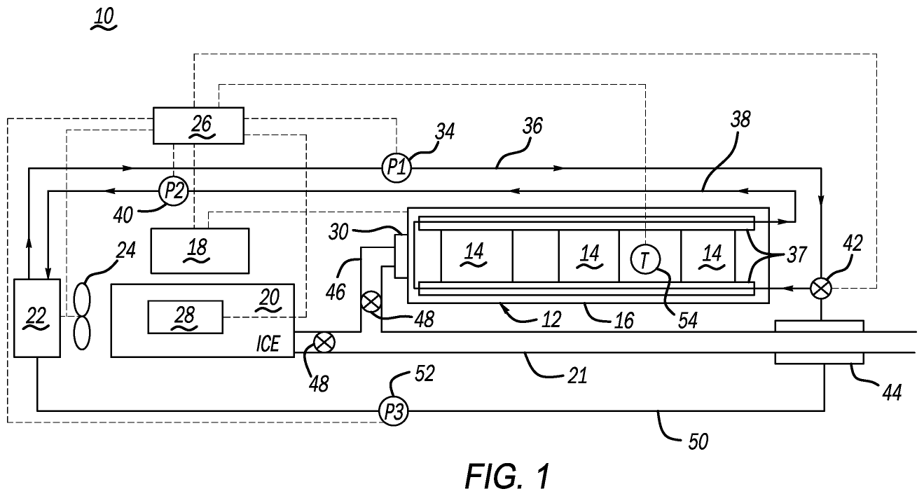

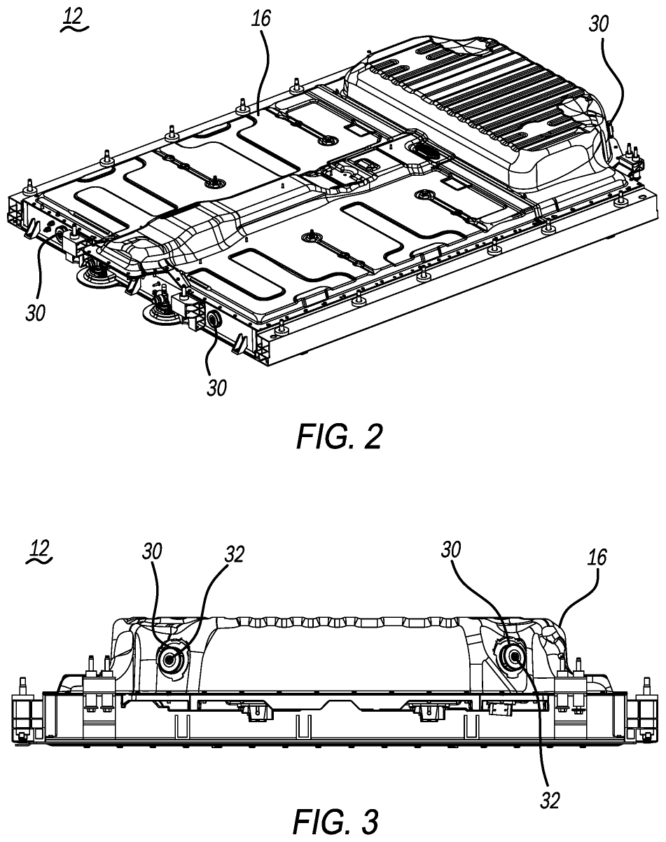

FIG. 1 is a schematic representation of a vehicle 10 according to a principle of the present disclosure. In the illustrated embodiment, vehicle 10 may be an electrically powered vehicle including a battery pack 12 that includes a plurality of battery cells 14. Example battery cells 14 include lithium-ion battery cells, lithium-metal battery cells, and combinations thereof. It should be understood, however, that other types of battery cells 14 known to one skilled in the art may be used, without limitation. Battery pack 12 includes a housing 16 that encases each of the battery cells 14. Housing 16 is preferably formed of a rigid metal material (e.g., steel, aluminum, and the like) that is resistant to puncture and is non-flammable. An example battery pack 12 is illustrated in FIGS. 2 and 3.

Still referring to FIG. 1, an electric drive module 18 is in electrical communication with battery pack 12. Electric drive module 18 may electrically actuate the wheels (not shown) of vehicle 10. While only a single electric drive module 18 is illustrated, it should be understood that vehicle 10 may include a plurality of electric drive modules 18. For example, the front wheels (not shown) of vehicle 10 may be driven by one electric drive module 18, while the rear wheels (not shown) may be driven by another electric drive module 18. Alternatively, each wheel (not shown) may independently be driven by a corresponding electric drive module 18. Regardless of the configuration selected, it should be understood that electric drive module 18 receives a voltage or current from battery pack 12 that is utilized by the electric drive module 18 to drive the wheels of the vehicle 10.

While not required, it should also be understood that vehicle 10 may also include an internal combustion engine (ICE) 20 such that vehicle 10 may be a hybrid electric vehicle. In the event that vehicle 10 is a hybrid electric vehicle including ICE 20, a tailpipe 21 for carrying exhaust gases generated by ICD 20 is connected to ICE 20. Vehicle 10 may also include a heat exchanger or radiator 22 and fan 24 for cooling ICE 20 during operation thereof. Vehicle 10 may include a controller 26 that may communicate with battery pack 12, electric drive module(s) 18, and an electronic control unit (ECU) 28 of ICE 20.

As noted above, battery cells 14 may sometimes undergo a process called thermal runaway during failure conditions of the battery cell(s) 14. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 12 increases, the pressure within battery pack 12 also increases. Housing 16 of battery pack 12, therefore, includes a plurality of vents 30, which are best shown in FIGS. 2 and 3, that permit the pressure and gases to escape housing 16. Vents 30 may each include a valve 32 that may be a one-way valve and opens upon a predetermine pressure threshold being generated within housing 16. For example, if the pressure within housing 16 reaches 100 millibars the valves 32 may open and permit the gases within housing 16 to exit the battery pack 12.

Heat exchanger 22 carries a coolant that may be used to cool battery pack 12. In the illustrated embodiment, coolant may be drawn to battery pack 12 by a first pump 34 through an inlet line 36. After entering housing 16, coolant can pass through heat sinks 37 in thermal contact with battery cells 14 that draw heat away from battery cells 14 to be exchanged with the coolant such that the coolant will absorb heat from the batteries 14 before exiting housing 16 through an outlet line 38. Coolant in outlet line 38 can be drawn back to heat exchanger 22 by a second pump 40 where the coolant can exchange the heat absorbed from the batteries 14 with the ambient air passing through heat exchanger 22 that is drawn by fan 24 until the process starts again.

The coolant of heat exchanger 22 can also be used to cool the hot battery exhaust gases generated during a thermal runaway event. In this regard, an electrically operated three-way valve 42 is illustrated in FIG. 1 in inlet line 36 upstream from battery pack 12. Three-way valve 42 is in communication with controller 26 and based on instructions from controller 26 can be used to direct the coolant to battery pack 12 or to a coolant jacket 44 that can be used to cool the hot battery exhaust gases, as will be described in more detail below.

During a thermal runaway event where gases are generated by batteries 14 that increase a pressure within housing 16 to an extent that one-way valves 32 of vents 30 are opened, the gases will exit housing 16 through vent(s) 30 and enter a conduit 46 that is fluid communication with vent(s) 30 (of which only one is shown in FIG. 1) and exhaust pipe 21 where the battery exhaust gases generated during thermal runaway can be led in a direction away from vehicle 10. Non-return (e.g., one-way) valves 48 may be located in conduit 46 and exhaust pipe 21 to prevent the battery exhaust gases from travelling in a direction toward ICE or back toward battery pack 12. Non-return valves 48 can be similar to one-way valves 32 provided at vent 30.

As the battery exhaust gases travel through exhaust pipe 21, it may be necessary to cool the battery exhaust gases so that the battery exhaust gases are less hazardous as the exit exhaust pipe 21 and enter the atmosphere. In this regard, the temperature of the battery exhaust gases in exhaust pipe 21 can reach up to 500 degrees C., which can cause objects located near exhaust pipes to be damaged or combust. When a thermal runaway event is detected, an instruction from controller 26 can be sent to three-way valve 42 to direct flow to coolant jacket 44, where the coolant enters cooling jacket 44 and as the hot battery gases pass through the portion of exhaust pipe 21 extending through coolant jacket 44, the coolant can absorb heat from the hot battery exhaust gases and thereby cool the hot battery exhaust gases. Coolant that has exchanged heat with the hot battery exhaust gases can exit coolant jacket 44 and enter a return line 50 that returns the coolant back to heat exchanger 22 where the process can repeat. To draw coolant through return line 50, a third pump 52 that is in communication with controller 26 may be used. Third pump 52 may only be necessary during a thermal runaway event and, therefore, may only operate during thermal runaway events based on instructions received from controller 26.

Similar to third pump 52 only operating during a thermal runaway event, it is important to note that three-way valve 42 only permits coolant to flow to coolant jacket 44 during thermal runaway. To determine whether a thermal runaway event is occurring, a sensor 54 may be present in housing 16 of battery pack 12. Sensor 54 may be a sensor that can generate signals indicative of temperature (as illustrated) that are transmitted to controller 26. During normal operation of vehicle 10, sensor 54 can be used to transmit signals indicative of the temperature of battery pack 12 and based on these signals, controller 26 can instruct first and second pumps 34 and 40 to increase or decrease in speed to adjust an amount of cooling provided to battery cells 14. If sensor 54, however, generates a signal indicative of a temperature in excess of 100 degrees C., this signal can be interpreted by controller 26 as a signal indicative of a thermal runaway event occurring at which time controller 26 can instruct three-way valve 42 to prevent flow of coolant to battery pack 12 and instead direct a flow of coolant to coolant jacket 44. Moreover, controller 26 may instruct first pump 34 to increase in speed and start operation of third pump 52 to provide an increased flow of coolant to coolant jacket 44 to provide increased heat transfer with the hot battery gases flowing through exhaust pipe 21.

While it is preferable that sensor 54 is a temperature sensor so that it can be used to assist in controlling cooling of battery cells 14 in battery pack 12 during normal operation of vehicle 10, it should be understood that sensor 54 may instead be a pressure sensor configured to generate signals indicative of pressure within housing 16. If the pressure within housing 16 reaches a predetermined threshold (e.g., 100 millibars), sensor 54 can transmit a signal indicative of this pressure to controller 26 at which time controller 26 can instruct three-way valve 42 to direct the flow of coolant to coolant jacket 44, instruct first pump 34 to increase in speed, and begin operation of third pump 52.

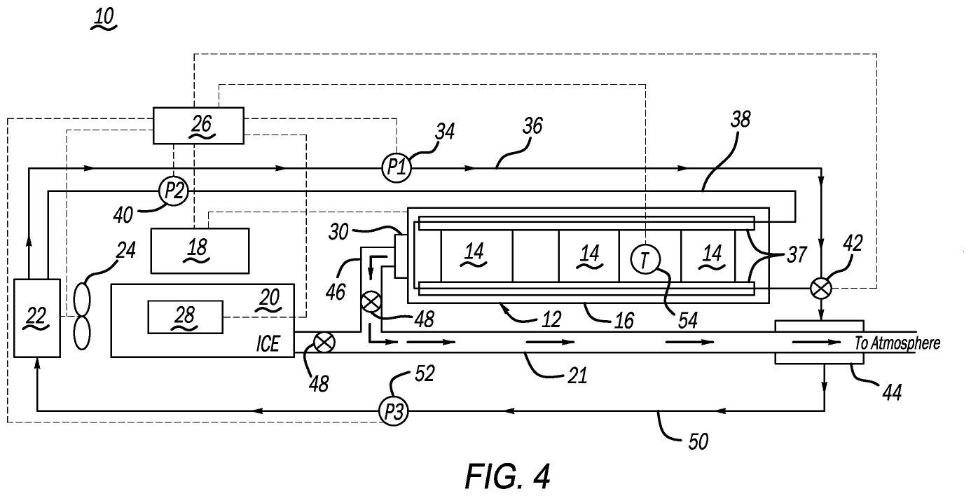

FIG. 4 illustrates the flow of coolant from heat exchanger 22 to three-way valve to coolant jacket 44 and back to heat exchanger 22. As shown in FIG. 4, the flow of coolant to battery pack 12 has stopped so that the flow of coolant can be focused on cooling the hot battery exhaust gases generated during thermal runaway. By passing the hot exhaust gases through the section of exhaust pipe 21 that is surrounded by coolant jacket 44, a temperature of the hot exhaust gases can be reduced to a less hazardous level (e.g. 300 degrees C. or lower). This lower temperature is less likely to damage objects near vehicle 10, and less likely to cause features of the vehicle from combusting. In addition, the cooler battery exhaust gases may permit people (e.g., first responders) to approach vehicle 10 to provide assistance to any occupants or attend to ceasing the thermal runaway event.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
an internal combustion engine in communication with an exhaust pipe;
a battery pack including a plurality of battery cells stored in a housing having at least one vent that is configured to discharge battery exhaust gases generated by the plurality of battery cells to the exhaust pipe;
a heat exchanger that is configured to cool the plurality of battery cells using a coolant that flows between the heat exchanger and the battery pack through a battery pack cooling loop;
a coolant jacket surrounding a section of the exhaust pipe that is in communication with the heat exchanger and configured to cool the battery exhaust gases in the exhaust pipe using the coolant that flows between the heat exchanger and the coolant jacket through a battery exhaust gas cooling loop; and
a three-way valve that controls flow of the coolant between the battery pack cooling loop and the battery exhaust gas cooling loop,
wherein the three-way valve prevents flow through the battery pack cooling loop during discharge of the battery exhaust gases from the exhaust pipe.

2. The vehicle according to claim 1, further comprising a controller and a sensor in communication with the controller that is configured to generate either a signal indicative of a temperature within the battery pack or a signal indicative of a pressure within the battery pack,
wherein the controller is configured to control the three-way valve to control the flow of the coolant between the battery pack cooling loop and the battery exhaust gas cooling loop based on the signals generated by the sensor.

3. The vehicle according to claim 2, wherein if the signal indicative of temperature or the signal indicative of pressure is above a predetermined threshold, the controller is configured to instruct the three-way valve to direct the flow of coolant to the battery exhaust gas cooling loop.

4. The vehicle according to claim 2, wherein the battery pack cooling loop includes an inlet line that extends between the heat exchanger and the battery pack and an outlet line that extends between the battery pack and the heat exchanger.

5. The vehicle according to claim 4, wherein the inlet line includes a first pump for drawing the coolant from the heat exchanger toward the battery pack and a second pump for drawing the coolant from the battery pack back to the heat exchanger.

6. The vehicle according to claim 5, wherein the three-way valve is located in the inlet line.

7. The vehicle according to claim 6, wherein coolant jacket is configured to receive the coolant from the three-way valve and return the coolant to the heat exchanger through a return line that extends between the coolant jacket and the heat exchanger.

8. The vehicle according to claim 7, wherein the return line includes a third pump for drawing the coolant from the coolant jacket back to the heat exchanger.

9. The vehicle according to claim 8, wherein the first, second, and third pumps are each in communication with the controller, and when the coolant is flowing through the battery exhaust gas coolant loop, the controller controls each of the first pump and the third pump.

10. The vehicle according to claim 8, wherein the third pump does not operate while the coolant is flowing in the battery pack coolant loop.

11. The vehicle according to claim 1, wherein the at least one vent is connected to the exhaust pipe by a conduit having a non-return valve positioned therein.

12. The vehicle according to claim 11, wherein a non-return valve is located in the exhaust pipe downstream from the internal combustion engine and upstream from a location where the conduit is connected to the exhaust pipe.

13. The vehicle according to claim 1, wherein the battery pack coolant loop includes at least one heat sink positioned in the housing that is configured to exchange heat with the coolant.

14. The vehicle according to claim 2, wherein the controller is configured to at least one of increase and decrease an amount of cooling provided to the battery pack based on signals indicative of temperature received from the sensor.
